(19) United States
(12) Patent Application Publication
(10) Pub. No.: US 2004/0001910 A1
(43) Pub. Date: Jan. 1, 2004

(54) Retaining minor nutrients and methods for manufacture of products

(76) Inventor: Liping Yu, Charlottetown (CA)

Correspondence Address: Michael R. Williams, Ade & Company, 1700-360 Main Street, Winnipeg, MB, R3C 3Z3, CA

(21) Appl. No.: 10/453,540

(22) Filed: Jun. 4, 2003

Related U.S. Application Data
(60) Provisional application No. 60/392,054, filed on Jun. 28, 2002.

(51) Int. Cl. A23K 1/00

(52) U.S. Cl. 426/615

(57) ABSTRACT

Minor components including phenolic compounds of fruits and vegetables are protected from deterioration by a method in which one or more types of materials from grains and pulses are brought into intimate contact with cut pieces or purees of the fruits and vegetables. The protection is achieved by coating or mixing of the protectant with fruits and vegetables. With the claimed protected system of fruits and vegetables, several methods of manufacture are further claimed that prepare the protected system into cooked food products in wet or dried forms. These methods included herein a process for manufacture of a food leather or chip product comprised of blending, drying and cutting, and for a paste or spread product from cooking a protected system.

This application claims priority under 35 USC §119(e) to Provisional Patent Application Serial No. 60/392,054 filed on Jun. 28, 2002.

### BACKGROUND OF THE INVENTION

Fruits and vegetables are well known to have health-benefits in their own right, and are liked by many in their diets. Due to many reasons such as lack of convenience and being highly perishable, they are the most lacking food groups in the North American diet. Processing of fruits and vegetables is challenging because they are highly perishable and, once disrupted, can easily lose their nutrient value over storage. This deterioration can often happen either through chemical reactions among their own components such as enzymes via a process called autolysis or by microbial attack owing to their nourishing composition, either of which results in a quick decline in quality. As a result, it has been difficult to transform fruits and vegetables into other forms that are more convenient and better liked, although fruit and vegetable juices represent some attempts. In these forms, however, the food products are usually only part of the original material, typically leaving the insoluble pomace out of the human food as a waste. Therefore, work in this regard has been only partially successful. It has not been possible to make a restructured product from ground/pureed fruits or vegetables without compromising the intrinsic quality of fruits and vegetables in final consumer foods.

Fruits and vegetables are living biological materials that contain enzymes and other life-sustaining nutrients. Proteins, carbohydrates and lipids are termed as macronutrients in the field of nutrition. Besides these, many other types of molecules, which are relatively minor in proportion, are sometimes called micronutrients, phytonutrients, or secondary metabolites. The micronutrients include those molecules such as phenolic compounds, vitamins such as ascorbic acid, and natural flavor compounds of fruit and vegetable. Basic biochemistry teaches that these nutrients are highly organized in compartmented organelles of normal cells, and do not come into contact with each other under normal conditions. However, once injured by physical means, the cells will release the enzymes that will act on the micronutrients and cause the loss of the nutrients and subsequent production of undesirable products such as polymers of the nutrients (see FIG. 18). As a result, the reactions will render the micronutrients useless in biological functions such as anti-oxidation. Therefore, fruit and vegetable products, if unprotected, take a dark color during and after processing as a consequence of the chemical reactions consuming the nutrients including the minor nutrients.

The prior art teaches that fruit and vegetable products require food additives to preserve their eating quality, color and minor nutrients such as phenolics and carotenotids (Woodroof and Luh, 1986 and Luh and Woodroof, eds. 1988; Dorantes-Alveraz and Chiralt, 2000 p 120). These additives for control of browning include SO₂ (sulfur dioxide in the forms of sulfurous acid, sodium or potassium bisulfites or metabisulfites), ascorbic acid, erythorbic acid, cysteine, EDTA, citric acid (Dorantes-Alveraz and Chiralt, 2000). Authorities like FDA regulate the use of these additives (FDA, 2001, 21 CFR1 84). It is common knowledge in the field that browning is caused by the action of oxidases that catalyze the oxidation of phenolic and other compounds such as chlorogenic acid, caffeic acid and catechol, flavonols and anthocyanins (Dorantes-Alveraz and Chiralt, 2000 p118). The reactions cause polymerization of the small phenolic compounds into colored polymeric molecules, rendering them unavailable to human absorption. In addition, blanching by hot water or steam is required to inactivate the enzymes to avoid excessive browning.

Recent literature lectures the beneficial health-promoting functions of these natural compounds as micronutrients in fruits and vegetables such as anti-microbial (see FIGS. 16 and 17), anti-oxidant and others (Lopez-Malo et al., 2000, p 242; Hall and Cuppett, 1997). Micronutrients are nutrients that are small in quantity but are required for normal physiological functions in living species. They function to protect living species through many mechanisms. One way to benefit the living species is to scavenge the free radicals that are generated even in normal biological process and cause malfunctions such as cancer and aging (Mazza, 1998). Many workers have pointed out the importance of these minor nutrients in human diet.

As a result, it is desirable to preserve these micronutrients, such as phenolic compounds. The loss of these compounds can be monitored by color changes as a result of transformation of these micronutrients into colored polymers. Tristimulus calorimeters have been widely used to obtain color coordinates, such as L, a, b system. In this system, L provides a measurement of lightness and darkness, the a value measures the red-green character and the b value measures the yellow-blue character (Shewfelt, 1986 p 505; Dorantes-Alveraz and Chiralt, 2000).

The current art teaches preserving the micronutrients by steam/hot-water blanching to destroy enzyme activity. This is followed usually by freezing to reduce the activity of enzymes and slow down biochemical reactions, or by drying to remove moisture medium that is required for microorganisms and enzymes to act on the micronutrients (as enzyme substrates). In addition to the loss of residual micronutrients due to blanching, chemical additives such as sulfite and ascorbic acid or acidulants are used in this process to aid the retention of micronutrients in the food materials.

Blanching is a step of heating (cooking) the fruits and vegetables by steam or hot water. The drawback of this method is many-fold: consuming energy and water, loss of nutrients into blanching water and by heat destruction, producing wastewater, and need of equipment. In conclusion, the step results in higher cost and lower quality products for the purpose of longer term keeping and preservation. In addition, the use of sulfur dioxide as a preservative has been in question because evidence indicates its use causes allergenic reactions in asthma patients. Nafisi-Movaghar (1991. U.S. Pat. No. 5,000,972) described a replacement for sulfite for preventing discoloration in fruit products that contains sugar, acid, an anti-microbiological agent and optionally a chelating agent that removes metal ions required for the activity of some enzymes.

Cereal grains and pulses have been the staple foods for people around the world since ancient times (Hoseney, 1986). None of the grains or grain-like products is used in the capacity of preservatives for fruits or vegetables.

Dried fruit products are well known. But the products are usually pieces of fruit and vegetable tissues in original biological structures. The dried products are usually brown-discolored, shrunken, rubbery or sugar infused semi-moist. The starting material mostly defines the shape and size of end products. Taga et al. (1993. U.S. Pat. No. 5,264,238) teaches the manufacturing of a snack food from ground fruits and vegetables with the optional use of starch to control moisture of the paste for moulding and texture. This invention required the conventional step of blanching to reduce browning and produce a dried product with a solid structure instead of puffing.

Encapsulation is a type of method for protection of food ingredients such as vitamins and volatile flavors. This method has only in recent years gained some attention (see for example Vilstrup, 2001, p 165). This is a method in which a stable molecule, called wall molecule in the field, is used to encase the labile molecule (core molecule). At least 50% up to 80% of the wall materials are required to achieve effective encapsulation. Bakan (1978) and Sparks (1985) have extensive lists of wall materials for food microencapsules that, however, are limited to pure or purified food ingredients such as gums, and starches and derivatives as carbohydrates, waxes in the group of lipids and gluten, wheat protein isolate, caseinate and gelatin in the group of proteins, and calcium sulfate and silicates as inorganic salts. There are several methods to achieve encapsulation, such as that documented by Vilstrup (2001). These methods include spray drying, extrusion, agglomeration, emulsion, coaceration and complexation by individual molecules. These methods are all intended to achieve a final state of fine particulates. It is however not possible to achieve a desired shape by using these methods.

Common knowledge in the field teaches that a physiochemical index, termed as glass transition temperature, determines the texture, like crispiness, of a food (Levine and Slade, 1989). Large molecules like starch, which has a high glass transition temperature, in a food formula will likely impact crispness to the foods (Zeleznak and Hoseney, 1987). Taga (1993) has used starch as the key food ingredient to produce a crispy snack product. However, starch has been consistently found to have poor protection for labile molecules (McNamee et al., 2001, p 3387). As a matter of fact, new molecules have instead been manufactured from starch by chemical reactions so that they have the desired protecting properties (Anandaraman and Reineccius, 1986; Vilstrup, 2001, p 152).

Lusas and Rooney (2001) have described extensively the manufacture of snack foods that are manufactured in the world. The snack foods described covered extensively on cereal grain based products. The products used raw materials extensively such as corn, potatoes, rice, wheat, animal tissues, legumes, but no information on fruits and vegetables. This reflected the difficulty of dealing with these materials for snack foods.

This invention describes an effective method for protecting and preserving the micronutrients so that the health-promoting factors can be preserved. These are small in amount but are recognized as health-promoting, disease fighting, health-beneficial components such as antioxidants and others. These micronutrients are also important in affecting the nutritional (such as vitamins) and sensory (color, texture and smell and taste) properties of the foods.

### SUMMARY OF THE INVENTION

According to a first aspect of the invention, there is provided a food product comprising: a quantity of at least one fruit or vegetable; and a protectant.

According to a second aspect of the invention, there is provided a method of preparing a food product comprising: mixing a quantity of at least one fruit or vegetable and a protectant; and blending the mixture.

According to a third aspect of the invention, there is provided a method of preparing a food product comprising: blending a quantity of at least one fruit or vegetable; and adding a protectant to the blended fruit or vegetable a protectant.

According to a fourth aspect of the invention, there is provided a method of preparing a food product comprising: providing a quantity of cut pieces of at least one fruit or vegetable; and dipping the cut pieces into a protectant.

According to a fifth aspect of the invention, there is provided a method of preparing a chip-like product comprising: steaming a pureed mixture of at least one fruit or vegetable and a protectant; cooling the mixture and sheeting the mixture; drying and puffing the sheet; and cutting the sheet into chips.

### BRIEF DESCRIPTION OF THE DRAWINGS

FIG. 1 shows the results on protective effects of different types of grain and pulse products on phenolic compounds of apples as measured by color change in the puree. Ascorbic acid, a traditionally used chemical is shown for comparison. A, the color lightness (L) decrease in the puree; B, the increase in redness (a) in the puree; and C, the increase in the yellowness (b) in the puree.

FIG. 2 shows the effect of blending time on the protective capability of quinoa flour against loss of micronutrients in apple puree as measured by color change. A, B, and C, the same as in FIG. 1.

FIG. 3 is an illustration of the protective capacity of the protectants (quinoa shown here) under different protectant to fruits/vegetable ratios. The protective strength is little affected by the protectant to fruit ratio; apple only is shown here for comparison. A, B, and C, the same as in FIG. 1,

FIG. 4 is an example for the protective effect of protectants (quinoa shown) on pureed mushroom. A, B, and C, the same as in FIG. 1.

FIG. 5 is an illustration of the protective capacity of the protectants (oat shown here) under different protectant to fruits/vegetable ratios. The protective strength is little affected by the protectant to fruit ratio; apple only is shown here for comparison. A, B, and C, the same as in FIG. 1.

FIG. 6 is an illustration on the protective capability of different fractions of the grain (wheat shown) against the loss of micronutrients as measured by color change. A, B, and C, the same as in FIG. 1. The starch fraction was the least effective among the protectants. A, B, and C, the same as in FIG. 1.

FIG. 7 is an illustration on the protective capability of different fractions of the grain (corn shown) against the loss of micronutrients as measured by color change. A, B, and C, the same as in FIG. 1. The starch fraction was the least effective among the protectants. A, B, and C, the same as in FIG. 1.

FIG. 8 is an illustration on the protective capability of different fractions of pulses (pea) against the loss of micronutrients as measured by color change. A, B, and C, the same as in FIG. 1. The starch fraction was the least effective among the protectants. A, B, and C, the same as in FIG. 1.

FIG. 9 is an illustration on the protective capability of different solutions/suspensions of grain (quinoa shown) against the loss of micronutrients as measured by color change. A, B, and C, the same as in FIG. 1. The 10% quinoa suspension was the most potent in depressing discoloration and reducing loss of micronutrients (Top) while the cooked and cooled solutions (5% and 10%) was more potent in retarding the increase in hues of redness and yellowness (middle and bottom). A, B, and C, the same as in FIG. 1.

FIG. 10 illustrates the effect of quinoa flour on the color of steamed apple purees. The quinoa flour was equally effective in retarding the discoloration of apple purees when either pureed with quinoa followed by steaming and when steamed followed by hot-pureeing with quinoa flour. The pureed and steamed apple only, used as a control has discolored (Top), and developed redness hue (middle) or yellowness hue (Bottom). A, B, and C, the same as in FIG. 1.

FIG. 11 shows a flowchart for the manufacture of the fruit and vegetable snack product (e.g. vegetable leather) using the protected systems containing fruits and vegetables and the protectant.

FIG. 12 is a flow chart for manufacture of a food spread by preparing/cooking a protected system of fruits and vegetables.

FIG. 13 is a flowchart for manufacture of cut pieces (e.g. dices) by preparing/cooking a protected system of fruits and vegetables.

FIG. 14 is a flow chart for manufacture of a chip-like product.

FIG. 15 is an alternate flow chart for manufacture of a chip-like product.

FIG. 16 shows the structure of naturally occurring plant compounds with antimicrobial activity.

FIG. 17 shows the structure of naturally occurring phenolic compounds with antimicrobial activity.

FIG. 18 shows some enzymatic and non-enzymatic browning reactions in minimally processed fruits and vegetables.

FIG. 19 shows the protective effects of grains on apple purees as measured by the residual concentration of phenolics in the purees. The apple puree without grains showed the lowest level of phenolics; the puree mixed with starch had the same residual concentration, indicating no protective effects of starch on apple phenolics. The apple puree with quinoa showed the greatest phenolics content while the puree with oats produced similar protective effects.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

As used herein, “blended”, “mixed”, “pulverized”, “pureed” and similar terms are used interchangeably and refer to the mixing of the fruits and/or vegetables into a blend, as discussed below.

As used herein, “coated” or “coating” in all grammatical forms in reference to a protectant coating a portion of a fruit or vegetable refers to the fact that the protectant sufficiently surrounds, coats or covers the portion. However, “coating” does not imply that the portion is entirely coated in the protectant, only that it is substantially coated. Examples of coating a portion of a fruit or vegetable in a protectant include but are by no means limited to dipping cut pieces of at least one fruit or vegetable into the protectant, pureeing or blending at least one fruit or vegetable and adding protectant thereto and pureeing or blending at least one fruit or vegetable in the presence of the protectant.

As used herein, “snack product” refers to a food product of any convenient size and/or shape for consumption. One example of a suitable size and/or shape is a chip or chip-like product.

In the present invention, fruits and or vegetables are cleaned to ensure hygienic conditions for human consumption. The clean fruits or vegetable are blended together with a protectant composition or cut pieces of the fruits or vegetables are dipped in the protectant, for example, a protectant composition comprised of one or more grain products to produce a paste that maintains the freshness and nutrients, including the micronutrients, such as phenolic compounds. The resulting food product may be formed into a paste, spread, sheet, or puffed to form a snack product, for example, a chip-like product as described below.

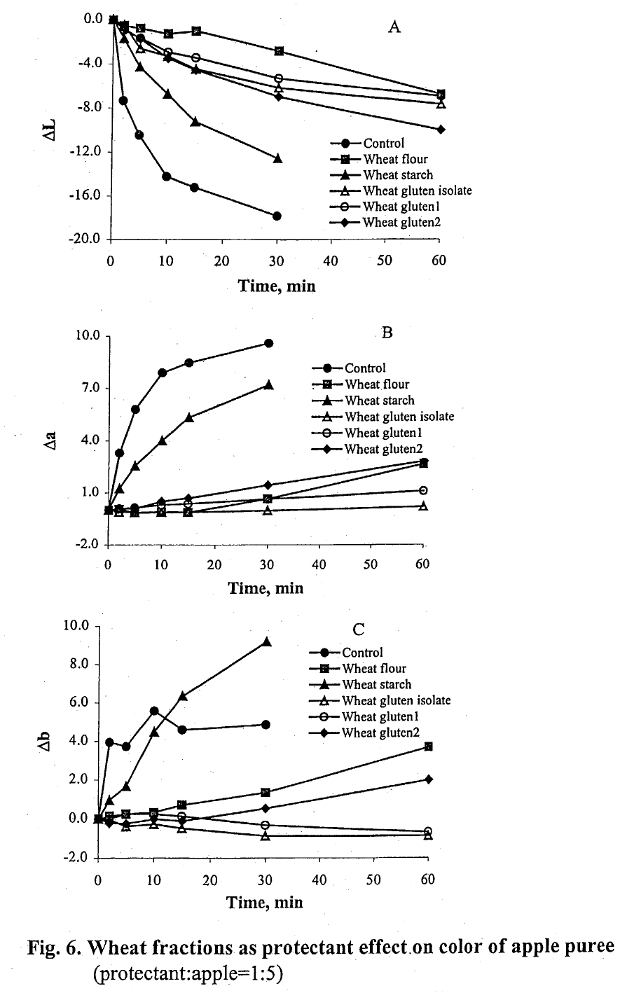

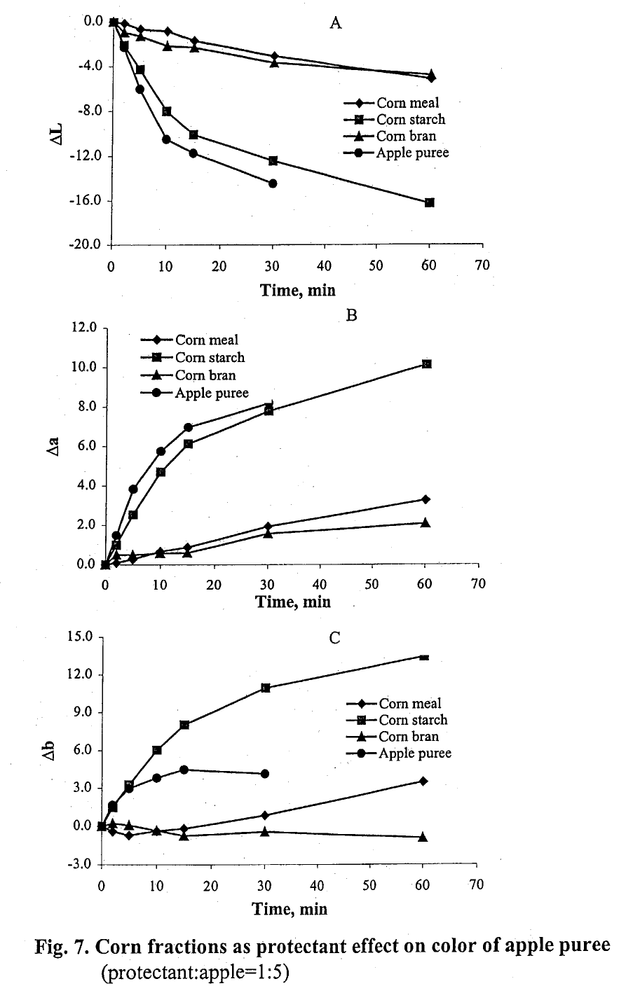

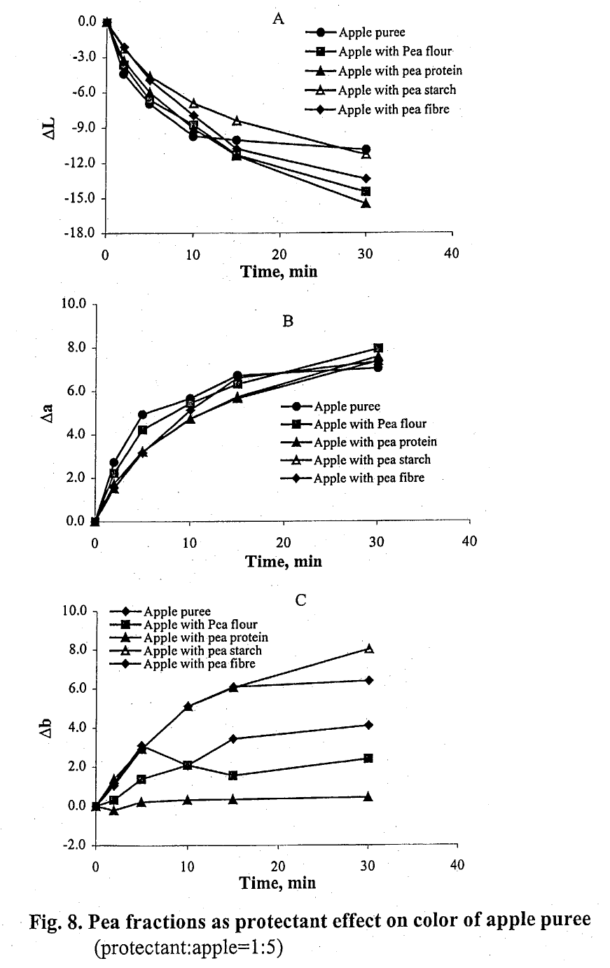

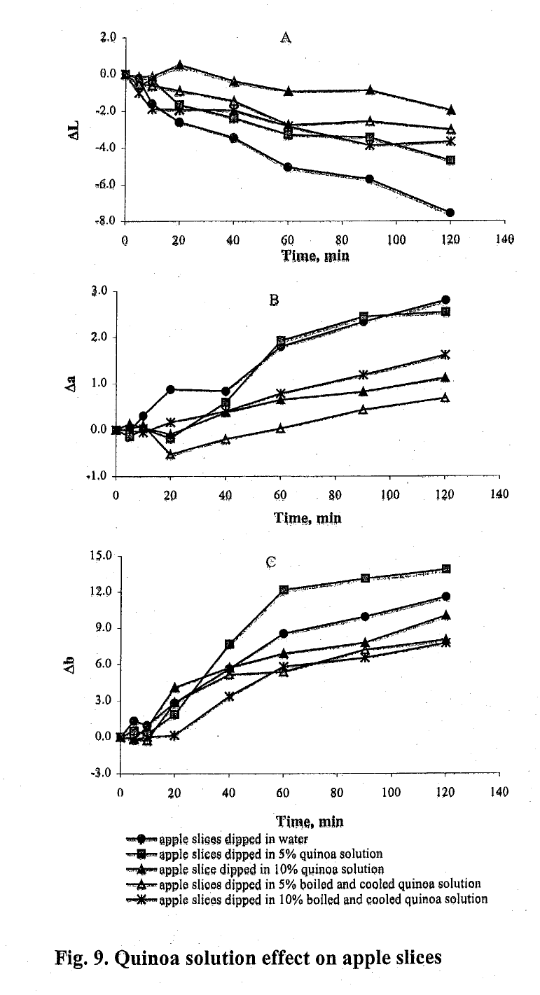

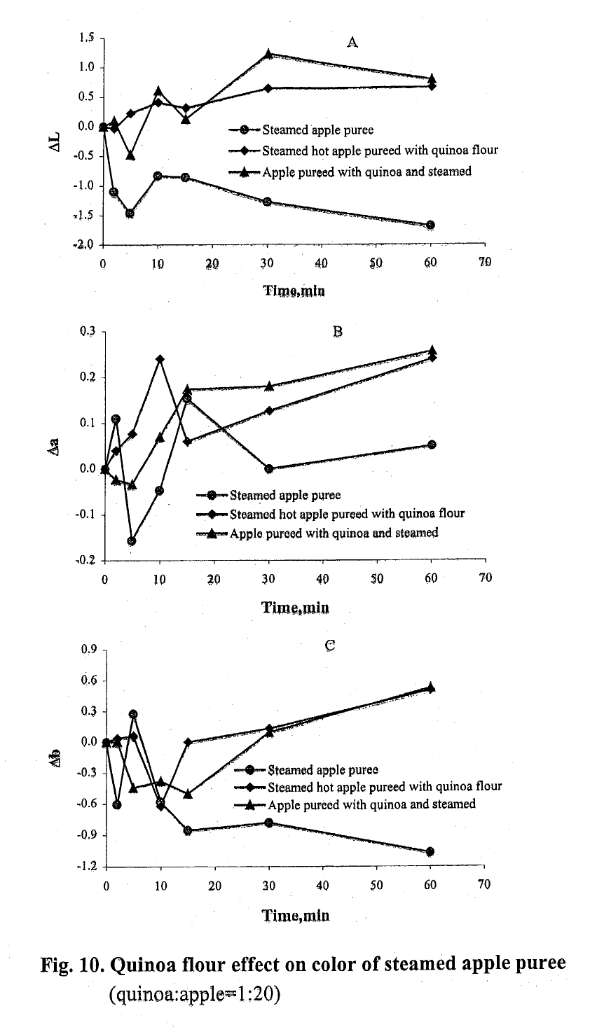

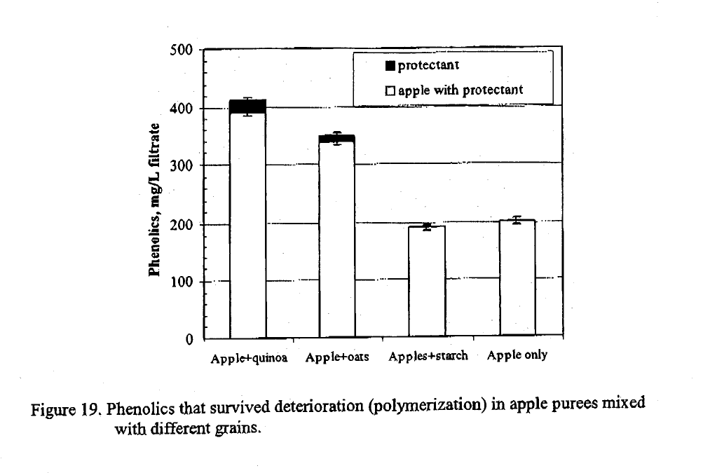

In one embodiment, the protectant refers to one or more types of grain materials, either whole grains or fractions thereof. In a preferred embodiment, the whole meal or flour of the grain is used as the protectant. It is another preferred embodiment that the fraction that contains the minor components be used as the protectant. However, if fractions are used, purified starch is not an effective protectant (FIGS. 6, 7, 8 and 19). Therefore, it is not a desired protectant. It is an advantage and embodiment of the invention that chemical preservatives like SO₂ or blanching can be avoided and the protectant in this invention is used in maintaining the freshness and quality of the pulverized fruits and vegetables.

In another aspect of the invention, there is provided a method of using a protectant that protects the nutrients of fruits and vegetables from deterioration due to chemical and biochemical reactions with oxygen and under heating. The method renders immediate and complete contact of the said protectant with broken tissues, cells and cell contents of raw or cooked fruits and vegetables through mixing actions such as blending, homogenization, pulverizing and agitation. The amount of the protectant depends on type of protectant, and ranges from less than 0.5 g to 75 g per 100 g of the fruits and vegetables for adequate protection of their minor compounds. The protectant impacts the protecting effects, either in raw or cooked forms before or after mixing, by being on the surface of the tissue pieces and cells, and mixed with cell contents (collectively called purees) of fruits and vegetables. Cooking of protectant and the fruits and vegetables takes place either before, during or after mixing of the protectant and the fruits and vegetables. The protection includes retention of quality against deterioration due to: i) loss or deterioration of minor food components which are sometimes called micronutrients, secondary metobolites or phytonutrients such as phenolic compounds, vitamins such as ascorbic acid, and natural flavor such as freshness of fruit and vegetable; or ii) formation of undesirable compounds such as brown compounds and/or off-flavor. Optional additions of other ingredients such as seasonings or nutrition supplements such as protein isolates range from 0-25% of the fruits and vegetables.

According to yet another aspect of the invention, there is provided a process for manufacture of a restructured product that is comprised of fruits and vegetables and a protectant as discussed above, with optional other ingredients such as seasonings, spices and flavorings. The process involves blending or pulverizing fruits and vegetables into a paste together with an added protectant, the proportion of which is between 1-75 g of protectant per 100 g of the fruit in the paste to achieve homogenization of the protectant with the broken fruit tissues, cells and cell contents. The paste may contain only fruit of one or more types, only vegetable of one more types or a desired combination of the fruit and vegetable; the protectant in the paste may be a product of one or a blend of more types of the grains. The paste is optionally cooked by steam, hot air or a hot surface. The paste, either previously cooked or still raw, is spread on to a flat surface or a belt with rims so that a layer of desired thickness of 1 to 10 mm is formed. The paste layer is now cooked by steam, hot air or a hot surface, if not previously cooked. The cooked paste sheet is dried, by air or radiant heat such as infrared heat, to moisture content of 10-30%. The heat is applied in such a way that the temperature of the paste (which becomes leathery toward the end of drying) will not exceed 100° C. so that there is no significant browning or other quality degradation caused by the heat. The resulting leathery sheet is subsequently cut into desired shape and size either on a flat surface of, e.g. a conveyer belt or a tray. The resulting pieces are cooled down to ambient temperature and then kept in dry, dark environment, optionally in an atmosphere of depleted oxygen such as in an air-tight package for a prolonged shelf-life before serving.

According to a further aspect of the invention, there is provided a process for manufacture of fruit and/or vegetable products that can be used as a spread in which the protectant as described above is used as the protectant and gelling agent, with optional use of flavor ingredients such as sweeteners and acidulants.

According to another aspect of the invention, there is provided the use of the protectant in the manufacture of cut (sliced, diced and other shapes) fruits and vegetables by dipping into the protectant ingredient slurry that is either cooked or raw.

In some embodiments, a product is manufactured from fruits, vegetables and protectant as the only essential ingredients, with optional ingredients such as seasonings and nutritional fortifiers like proteins. The product may contain a combination of fruits and a protectant, of vegetables and a protectant, or of fruits and vegetables and a protectant, each as the essential composition of a product. The protectant may be prepared from a product of grains, pulses, tubers and other grain-like food materials. The grains and pulses may include the grains and edible parts of quinoa (Chenopodium quinoa), oat (Avena spp.), wheat (Triticum aestivum L., turgidurn and durum), corn or maize (Zea mays), buckwheat (Fagopyrurn spp.), pea (Pisurn sativum), barley (Hordeum spp.), rice (Oryza sativa), potato (Solanum spp.), millet (Pennisetum glaucum (L.)R.Br.), rye (Secale sp.), sorghum (Sorghum bicolor (L.) Moench), and triticale (Triticosecale sp.). The protectant, which is a combination of at least one whole or fraction product (e.g. flour, meal and fibre fraction) of the food materials, hereto and hereafter termed as the protectant, is a combination of at least one product from at least one species of the groups mentioned above. The product may be in wet, semi-moist or dried forms as a result of manufacture by drying or dehydration of the formulations described herein.

The protection is achieved by contact of the protectant either on the surface, in the tissue or among the cells and cell contents of the fruits and vegetables. Dipping or soaking is adequate for cut tissues of the fruits and vegetables without totally destroying the texture/structure of original tissues. Contact brought out by mixing or by blending is optimal when a complete and thorough mixing is achieved among the fruit/vegetable and protectant. The required mixing could be achieved by blending for a period of time ranging from instantaneous to up to 10 min, depending on the efficiency of the mixer/blender. Excessive blending wastes energy and promotes excessive contact of paste with the atmosphere. As will be appreciated by one of skill in the art, the exact time of blending will vary according to the fruits and/or vegetables being mixed and the device used for the mixing. The above conditions are for illustrative purposes and are by now means limiting.

The inclusion of fruit seeds and skin does not affect the efficiency of the protecting power. The removal of stems, skin and seed is, therefore, optional. As a matter of fact, these may be included as part of the paste whenever desired. If removal is desired, the timing of their removal is optional, which may happen either prior to or after blending. For additional sensory and nutritional qualities of the paste, the paste of fruit/vegetable and protectant may be prepared with additional food ingredients, flavorant, spices and seasonings during blending or after the fruit/vegetable-protectant paste is made.

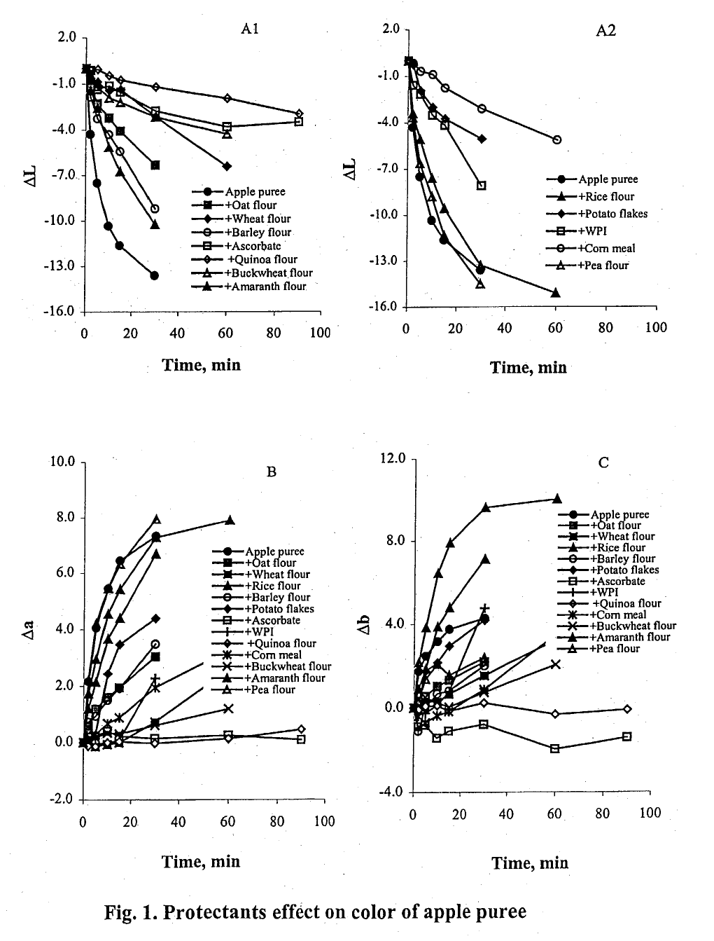

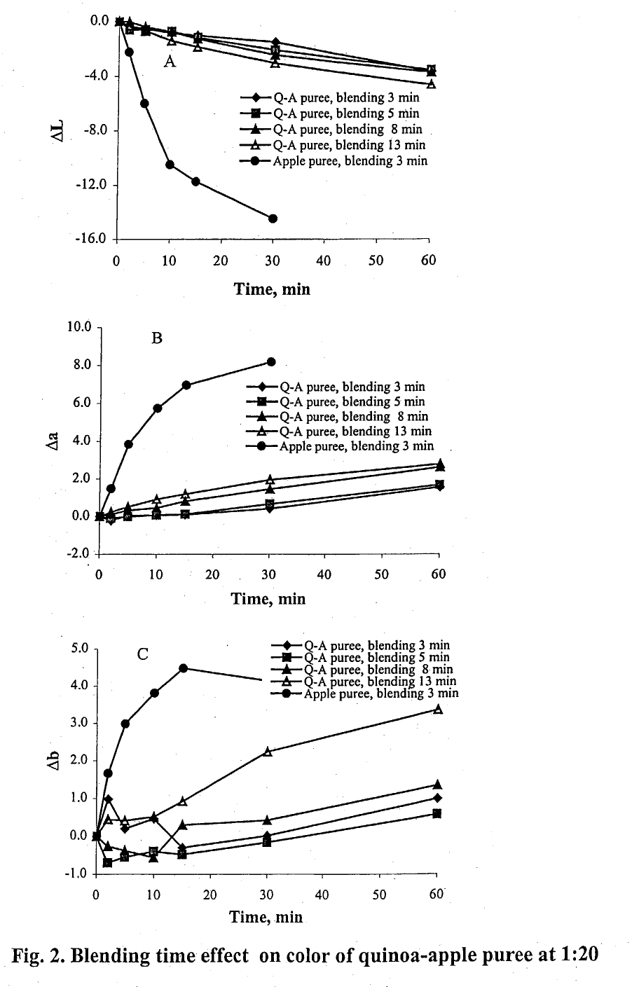

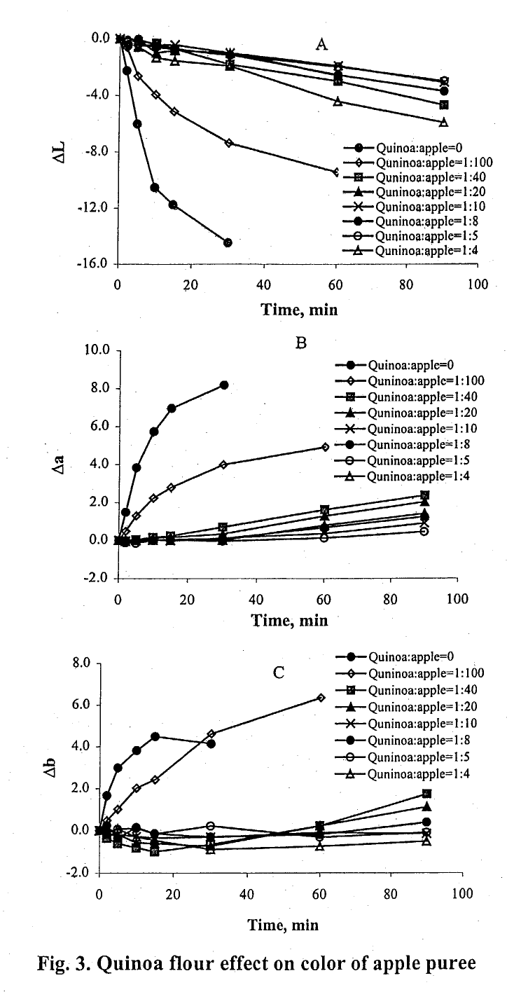

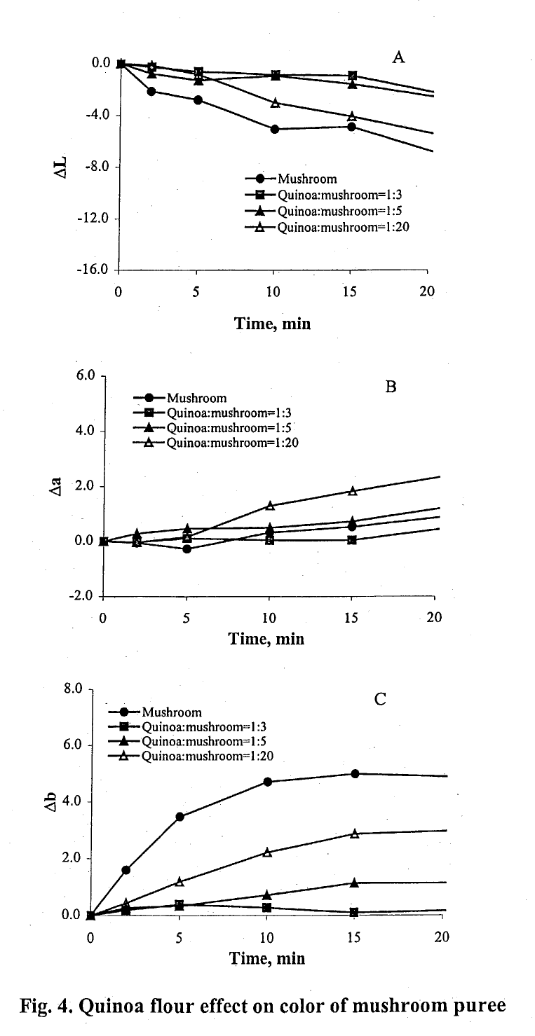

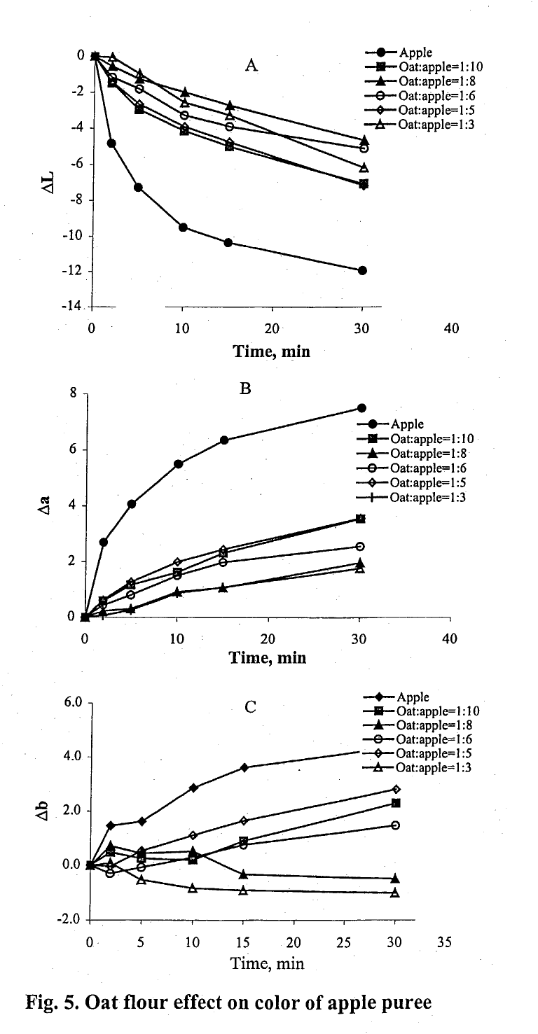

The prepared paste is stable for differing lengths of time, ranging from at least 10 min to many hours, depending on the type of protectant used and the protected fruit/vegetable. Quinoa flour, for example, maintained the stability and protection for at least several hours, and is superior to ascorbic acid, the most powerful preservative currently used for fruits and vegetables (FIG. 1). Protection by common wheat and buckwheat flours lasted for a slightly shorter period of time than by quinoa flour. It is of note that potato and corn meals are also among those with high protecting power.

Whey protein isolate, which is used here as a nutrition fortifier in examples of this invention, showed very low protecting power. Fractions of wheat, corn and pea (FIGS. 6, 7 and 8, respectively) are individually tested for power of protection. In all cases, the starch fraction as a purified industry product is the least effective fraction for protection among other fractions and the parent raw materials. It is likely that the minor components of the grain products are most powerful in protecting fruits and vegetables, but it is also possible that the protecting power comes from a synergism of several components of the grain. It is preferred that the whole grain is used as the protectant for stabilization of fruits and vegetables.

Cooking of the protectant or the fruits and vegetables does not alter the capability of the protectant to protect the micronutrients. Therefore, cooking may take place before, during or after the mixing of protectant with fruits and vegetables, depending on the convenience in overall operation of manufacture. If not cooked prior to the manufacture of the protected system, the prepared paste is, as a following step, cooked to inactivate the enzymes that usually cause immediate loss of phenolic compounds in an unprotected system. The cooking also destroys any microorganisms that are eventually harmful to the hygiene of the paste. As a result of the protecting effect of the protectant, the paste is stabilized in quality and safety with the original nutrients of the raw materials. For best economic advantage, it is preferred that cooking is carried out immediately after the protected paste is prepared so that no repeated heating and cooling is required and no loss of nutrients takes place in cooking water.

The paste, if cooked, may serve as the end product that is used, for example, as a high quality spread. The protected paste, either cooked or uncooked, are even further processed into other products by dehydration as described as follows.

One method of further processing from the protected paste system in this invention is to make a sheet of the paste and dry the paste into a sheet of leathery texture. The cooking and drying may be carried out by the same heating method or alternatively by other means known in the art. Steaming is the preferred method of heating since vapor shields the food paste from the oxygen atmosphere that may cause oxidation of susceptible micronutrients, In the case of steaming cooking, the cooked mixture is dried down to a moisture content of 15-30% with a resulting sheet of a thickness of 1-5 mm. As will be apparent to one of skill in the art, other suitable thicknesses and moisture contents may also be used.

Alternatively, cooking is also achieved by radiant heating such as microwave or infrared, with complementing air heating. The cooked sheet is further dried to result in a leathery sheet with moisture content of 10-30%, but preferably 10-15%. The air temperature for cooking was below 120° C., preferably below 100° C. This leathery sheet may be consumed as a food product with feature flavor of the raw produce but with a texture from soft and moist to tough like beef jerky.

In some embodiments, the food product as described above is formed into a snack product for example a chip-like shape, although other suitable shapes may also be used. The chip-like food product may be further processed to form a puffed chip, as discussed below. As will be appreciated by one of skill in the art, this form of food product has several advantages, including portability and consumer recognition, in addition to the health benefits discussed above. Specifically, the food product is prepared by steaming a pureed mixture of at least one fruit or vegetable combined with a protectant as discussed above, thereby inactivating enzyme reaction and gelatinizing starch. The mixture is then cooled down to 35-50° C. and sheeted to thickness of 1-2 mm. The sheets are dried to a moisture content of approximately 10-20% by vacuum or regular drying. Mean drying temperature was 60-100° C. The sheets are cut into chip shapes and are equilibrated. As will be appreciated by one of skill in the art, a variety of suitable shapes are well-known in the art and may be used within the instant invention. The chips were then puffed, for example by applied microwave heating or by applied infrared although other suitable means known in the art may also be used. After puffing, the chips are subjected to a finish roasting to a moisture content of approximately 3-4%. The finished product is then packed and ready for consuming.

In other embodiments, mixture may be extruder formed into strips, prior to drying the strips to a moisture content 25-35% at about 100° C. The sheets are then dried and cut into chip shapes as discussed above. and were equilibrated.

In another embodiment of the invention, the protectant solution, either raw or cooked, may be used to coat pieces (e.g. dice or slices) of fruits and vegetables to prevent color change on the surface of the tissues. It is preferred that the protectant slurry is cooked so that the fruits and vegetables are ready to eat after coating. The preferred concentration is at least 2-5 g per 100 g of water, although much higher concentrations may also be used, depending upon the conditions, for example, the protectant and the fruits and/or vegetables coated therewith.

Manufacture of Protected Systems

It is a fundamental part of this invention that grain materials are discovered to be effective protectants in retarding discoloration and protect the micronutrients of the fruits and vegetables from losses due to oxidation and polymerization. While several grain and pulses have been tested, it is obvious that the grain and pulses (FIG. 1) are just a few of many food materials that have natural, strong protective effects against deterioration of micronutrients in fruits and vegetables. These results have established the foundation in this invention that grain and pulses materials are strong protectants for micronutrients. Although essentially all tested materials are suitable for protecting fruits and vegetable, quinoa, corn, wheat, and oat are the strongest, and among the preferred materials for protection of fruits and vegetables.

Among the fractions of the grains, pulses and grain-like food materials, it is a preferred embodiment that the fraction that contains the micronutrients in the protectant is used as the protectant. For the purified fractions, the starch fraction is the least effective one and should be avoided for protectant.

In view of how the protection is achieved, it is preferred that the contact takes place as soon as possible with the tissues and cell contents of fruits and vegetables after they are cut open. Dipping into the slurry, either cooked or raw of the protectant, or a mixture of several protectants is preferred for pieces of fruits and vegetables. For pureed paste, it is preferred that the blending together with the protectant is preferred than blending the ingredients separately followed by re-blending.

In manufacture of the protected paste, the protective potency of the discovered grain materials seems to allow a wide length of blending time without compromising the efficacy of the protective effects. It is preferred that the proper blending/mixing time is less than a few minutes and as soon as complete mixing is achieved for complete contact of the protectant and the fruits and vegetables, since excessive blending simply wastes energy and causes unnecessary exposure to atmosphere oxygen.

It is preferred that the protectant is in contact with the fruits and vegetables as soon as convenient. Whether the protectant is in raw or cooked conditions, however, depends on convenience of processing. Since cooking does not alter the protective capability of the protectants, cooking may take place before, during or after the contact is made. However, it is preferred that cooking is made after the contact takes place so that loss of micronutrients is minimized.

Manufacture of Fruit and Vegetable Leathery Product

It is another aspect of the invention that the protected system, particularly the paste system, may be dried to produce a leathery product. Although it is feasible to use any heat source to dry the protected system, it is preferred that protected system in paste form be sheeted prior to drying, making drying more efficient. It is another aspect of the invention that the sheet may be made either prior to cooking or after cooking when leathery product is the intended product.

It is preferred that cooking takes place after sheeting so that energy may be preserved because cooking and drying may take place at the same time. Although it is possible to sheet the product after cooking, it is preferred that sheeting is made by extrusion so that the protected system may be made into sheets regardless of the consistency of the paste. It is preferred that the extruded sheets be rolled after cooking and certain degree of drying so that there will be a smooth surface on the sheet. It is another preferred aspect that the sheet is left dry without rolling if the sheet is formed after cooking.

Where sheeting takes place after cooking, the cooked protected system is first cooled down to below 65° C., preferable, between 35-50° C. so that the system is easily sheeted. The protected system is then sheeted to thickness of 1-5 mm, preferably between 1-2 mm. The sheet is then dried to moisture content between 10-30%, preferred at 10-15%. The drying temperature was below 120° C., preferably below 100° C. Drying can be carried out either under atmosphere or optionally under a vacuum. Finally the sheets were cut into desired shapes such as diamond, square or rectangular. However, it is preferred that they are cut into easily serviceable shape and sizes depending on the way of consumption. The sheets are preferred to be cut into relatively small, snap-type chips, either in geometrical or animal/plant shapes that are liked by the intended consumer. As will be appreciated by one of skill in the art, the chip-like food product has several benefits, including portability.

Manufacture of Fruit and Vegetable Puffed Chip Product

FIG. 11 illustrates a method of manufacture for the food leather/chip from the protected system. The protected system in the form of a paste is extruded or pumped through a die of a forming extruder or a former so that a sheet of the protected system is made onto a tray or belt. The sheet is steamed while the tray or belt is moving and as a result, the sheet is cooked. The cooked sheet is then dried by blowing hot air to the sheet, cooled down by cold air to below 65° C., preferable, between 50-35° C. In the course of drying or cooling, the sheet is rolled to a thickness of 1-2 min using a sheeter, and the sheet is finally dried to a moisture content of 30-10%, preferred at 10-15% by vacuum or regular drying. The drying temperature was preferably below 120° C. The sheet was cut into different shapes as desired for a leather product, such as square or roll. The finished product was portioned and packed; and optionally in light-tight and oxygen-depleted bags for long term keeping prior to consumption.

As described earlier and demonstrated by the examples below, there are several steps in the flowchart may be performed in optional sequences in the flowchart. However, the spirit of the invention can easily be followed that utilizes the protected system.

Manufacture of Fruit and Vegetable Spread

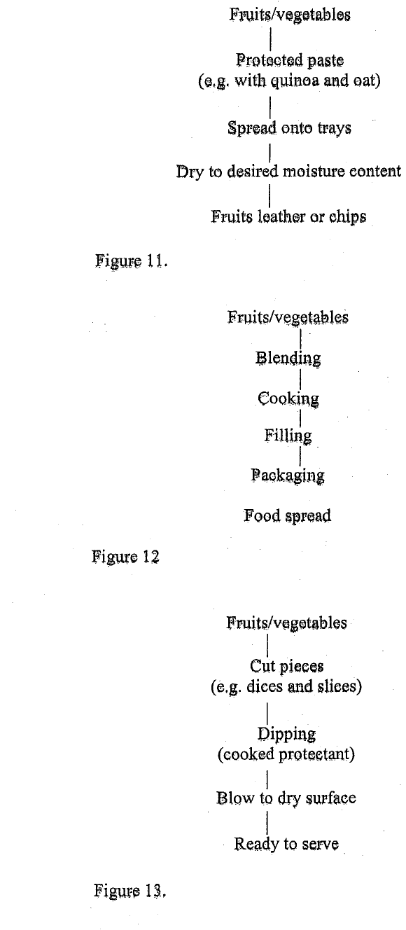

It is another aspect of the invention that the protectant is used to manufacture a spread product of fruits and vegetables (FIG. 12). The blending of protectant with fruits and vegetables essentially constitutes the manufacture of a spread product of fruits and/or vegetables or a mixture thereof It is preferred that cooking will take place immediately after blending to prevent microbial growth and gradual loss of micronutrients due to prolonged exposure to air. On the other hand, cooking may take place before or during the blending process.

Manufacture of Fruit and Vegetable Cut Pieces

It is another aspect of the invention that the protectant is used to manufacture a product of cut pieces of fruits and vegetables (FIG. 13). In this application, the protectant may be in raw form in a suspension or in a cooked solution. For ready-to-eat products, it is obviously advantageous to use cooked protectant to coat the cut pieces. However, if the cut pieces are to be cooked or the protectant is to be removed from the pieces for further processing, it is equally effective to use raw protectant materials for protection of the cut pieces of fruits and vegetables. It is preferred that a fast dipping or otherwise short contact between the protectant and the cut pieces are desired to minimize the leaching of micronutrients from the cut pieces.

The invention will now be described by way of examples. However, the invention is not limited to the examples.

### EXAMPLES

Materials and Methods

Materials

All materials are either purchased at local super markets and specialized retail stores. Fresh fruits and vegetables or frozen produce are from Serca (Winnipeg, MB). These produce products include apples (Red Delicious, Golden Delicious, Granny Smith), crabapples (Morden Agriculture Canada Research Centre, MB), raspberries from (ADL foods, Summerside, PEI), apples (Paulared and Cortland) from Maple Farms (Montague, PEI), carrots, beets, and broccoli (purchased at local superstores).

Cereal products and related or similar products are from local stores and some types are also from commercial sources for comparative purpose: whole oat and de-branned oat flour from Can-Oat Products Ltd. (Portage la Prairie, MB), starch, wheat (Robinhood brand), and rice flours (Erawan brand, Thailand, purchased at Oriental Supermarket, Winnipeg, MB), quinoa flour and amaranth flour from Northern quinoa (Kamsack, SK), and potato flakes from McCain Ltd. (Portage la prairie, MB).

Whey Protein Isolate was from Erie Foods International, Inc. (Rochelle, Ill.), soy protein isolate from Protein Technologies International (St. Louis, Mo.). Ascorbic acid used a control or in certain formulations is from a commercial source.

Physical, Chemical and Quality Analysis

Moisture content: final product has 3 to 4% (wet bases).

Proximate analysis.

Volume increase/change: 1.5 to 4 times of original thickness.

Color measurements: depend on the fruits/vegetable ingredients, the color would have the typical original fruits/vegetables color,

Sensory evaluation; Crispiness/crunchiness measurement.

Methods of Process and Analysis

Unit Operations

Blending equipment: KitchenAid Ultra Power Blender, St. Joseph, Mich., USA

Sheeting equipment: Ampia Deluxe Pasta Machine, Italy

Drying equipment: Jenn-Air Self Clean Convection Oven

Packaging: MU842/Adh./1.25 Mil Clear LDPE Package bag,

Color measurement: Minolta Chroma Meter CR-300

Analysis of phenolic compounds: Method of Singleton and Rossi (1965).

### Example 1

Materials: Apples, Oat Flour, Barley Flour, Potato Flakes, Whey Protein Isolate, Rice Flour.

I. Apples were washed and peeled then cored to remove the seeds

II. Clean apples (160 g) are cut into pieces so that they can be pureed using a kitchen blender.

III. Add oat flour (32 g), and the mixture was pureed to homogeneity.

IV. The color of puree mixture was measured with a Minolta Chronia Meter using L, a, and b scale at 0, 2, 5, 10, 15, and 30 min.

V. Same measurements were preformed using apple (160 g) to barley flour (32 g), potato flakes (32 g), or rice flour (32 g).

VI Same measurement was preformed using apple (160 g) to Whey protein isolate (5.0 g)

VII. Apple puree (200 g) as a control.

Results (FIG. 1): a protected system by oat flour was manufactured. The controls with apple puree only and with ascorbic acid indicate the efficacy of oat flour as a protectant.

### Example 2

Materials: Apples, Ascorbic Acid, Quinoa Flour, Buckwheat Flour, and Amaranth Flour.

I. Apples were washed and peeled then cored to remove the seeds

II. Clean apples (200 g) are cut into pieces so that they can be pureed using a kitchen blender.

III. Add quinoa flour (40 g), and the mixture was pureed to homogeneity.

IV. The color of puree mixture was measured with a Minolta Chroma Meter using L, a, and b scale at 0, 2, 5, 10, 15, 30, 60, and 90 min.

V. Same measurement preformed using apple (200 g) to amaranth flour (40 g) and buckwheat flour (40 g).

VI. Same measurement was preformed using apple (200 g) to ascorbic acid (3.0 g).

VII. Apple puree (200 g) as a control.

### Example 3

Materials: apples, corn meal, corn bran, and cornstarch.

I. Apples were washed and peeled then cored to remove the seeds

II. Clean apples (200 g) are cut into pieces so that they can be pureed using a kitchen blender.

III. Add corn meal (40 g), and the mixture was pureed to homogeneity.

IV. The color of puree mixture was measured with a Minolta Chroma Meter using L, a, and b scale at 0, 2, 5, 10, 15, 30, and 60 min.

V. Same measurements were preformed using apple (200 g) to corn bran (40 g), or corn starch (40 g).

VI. Apple, puree (200 g) as a control.

### Example 4

Materials: Apples, Wheat Flour, Wheat Gluten Isolate, Wheat Gluten, and Wheat Starch.

I. Apples were washed and peeled then cored to remove the seeds

II. Clean apples (200 g) are cut into pieces so that they can be pureed using a kitchen blender.

Ill. Add wheat flour (40 g), and the mixture was pureed to homogeneity.

IV. The color of puree mixture was measured with a Minolta Chroma Meter using L, a, and b scale at 0, 2, 5, 10, 15, 30, and 60 min.

V. Same measurements were preformed using apple (200 g) to wheat gluten (40 g), wheat gluten isolate (40 g), or wheat starch (40 g).

VI. Apple puree (200 g) as a control.

### Example 5

Materials: Apples, Pea Flour, Pea Protein, Pea Fibre, and Pea Starch.

I. Apples were washed and peeled then cored to remove the seeds

II. Clean apples (200 g) are cut into pieces so that they can be pureed using a kitchen blender.

III. Add pea flour (40 g), and the mixture was pureed to homogeneity.

IV. The color of puree mixture was measured with a Minolta Chroma Meter using L, a, and b scale at 0, 2, 5, 10, 15, and 30 min.

V. Same measurements were preformed using apple (200 g) to pea protein (40 g), pea fibre (40 g), or pea starch (40 g).

VI. Apple puree (200 g) as a control.

### Example 6

Materials: Apples, Quinoa Flour.

I. Apples were washed and peeled then cored to remove the seeds

II. Clean apples (200 g) are cut into pieces so that they can be pureed using a kitchen blender.

III. Add quinoa flour (2 g, quinoa:apple=1:100), and the mixture was pureed to homogeneity.

IV. The color of puree mixture was measured with a Minolta Chroma Meter using L, a, and b scale at 0, 2, 5, 10, 15, 30, 60, and 90 min.

V. Same measurement were preformed to quinoa: apple=1:40, 1:20, 1:10, 1:8, 1:5, and 1:4.

VI. Apple puree (200 g) as a control.

### Example 7

Materials: White Mushrooms, Quinoa Flour.

I. Clean mushrooms (200 g) are cut into pieces so that they can be pureed using a kitchen blender.

II. Add quinoa flour (10 g, quinoa:mushroom=1:20), and the mixture was pureed to homogeneity.

III. The color of puree mixture was measured with a Minolta Chroma Meter using L, a, and b scale at 0, 2, 5, 10, 15, and 30 min.

IV. Same measurements were performed to quinoa:mushroom=1:5 and 1:3.

V. mushroom puree (200 g) as a control.

### Example 8

Materials: Apples, Quinoa Flour.

I. Apples were washed and peeled then cored to remove the seeds.

II. Clean apples (200 g) are cut into pieces so that they can be pureed using a kitchen blender.

III. Add quinoa flour (10 g, quinoa:apple=1:20), and the mixture was blended for 3 min (minimal puree time).

IV. The color of puree mixture was measured with a Minolta Chroma Meter using L, a, and b scale at 0, 2, 5, 10, 15, 30, and 60 min.

V. Same measurements were preformed to blending time 5, 8, and 13 min.

VI. Apple puree blended for 3 min as a control.

### Example 9

Materials: Apples, Quinoa Flour.

I. Apples were washed and peeled then cored to remove the seeds.

II. Clean apples (200 g) are cut into pieces so that they can be pureed using a kitchen blender.

III. Adding quinoa flour (10 g, quinoa:apple=1:20), and the mixture was pureed to homogeneity.

IV. Steaming clean apples (200 g), and pureeing steamed apple with quinoa flour (10 g).

V. The color of puree mixtures were measured with a Minolta Chroma Meter using L, a, and b scale at 0, 2, 5, 10, 15, 30, and 60 min.

VI. Apple puree blended for 3 min as a control.

### Example 10

Materials: Apples, Quinoa Flour.

I. Apples were washed and sliced.

II. Add quinoa flour into 100 mL water (5% and 10%) and mix well.

III. Dip apple slices in the quinoa flour solution.

IV. The color of dipped apple slices was measured with a Minolta Chroma Meter using L, a, and b scale at 0, 2, 5, 10, 15, 30, 60, and 120 min.

V. Same measurement was preformed to boiled and cooled down quinoa flour solution (5% and 10%).

VI. Apple slices dipped in 100 mL water as a control.

The processes for manufacture of a fruit snack are described below. In these embodiments, the packaging equipment is MU842/Adh./1.25 Mil Clear LDPE Package bag, and Color measurement is performed using Minolta Chroma Meter CR-300. As will be apparent to one of skill in the art, other suitable equipment may also be used.

### Example 11

Materials: Apple, Oat Flour, Whey Protein Isolate, and Ascorbic Acid.

Steps:

I. Apples were washed to remove any adhering dirt or tree leaves and the stems and then cored to remove the seeds

II. Clean apples (800 g) am cut into pieces so that they can be pureed using a kitchen blender.

III. Add oat flour (80 g), whey protein isolate (20 g), ascorbic acid (3 g), and corn starch (80 g), and the mixture was pureed to homogeneity.

IV. The puree mixture was steam-cooked.

V. Then, the cooked mixture was cooled down to 35-50° C.

VI. The cooled mixture was sheeted to thickness of 1-2 mm using a pasta maker.

VII. The sheets were left on a tray and dried to moisture content of around 15.6%. The drying temperature was 60-100° C.

VIII. The sheets were cut into triangle shaped chips. The chips were left together and the moisture contents were equilibrated among the chips.

IX. Then, the chips were suddenly heated for 2 min with an infrared heater to produce blisters on the surface.

X. After puffing, the chips were put through an oven at temperature of 90° C. until the moisture content reaching 3.4%.

XI. The finished product had a crunchy and pleasant texture and was ready for consuming. It was packed in a moisture-tight bag and sealed for later consumption.

### Example 12

Materials: Apple, Rice Flour, Whey Protein Isolate and Ascorbic Acid.

Step:

I. Washing and pureeing apples (800 g) using a blender.

II. Adding rice flour (160 g) and whey protein isolate (20 g). Adding ascorbic acid (3 g).

III. Steaming the pureed mixture for cooking the product.

IV. Then, the mixture cooling down to below 50-35° C. Sheeting to thickness of 2-1 mm.

V. The sheets were dried to moisture content to around 15%. The drying temperature was 60-100° C.

VI. The sheets were cut into triangle chip shapes. The chip shapes were equilibrated for uniform moisture content.

VII. Then, the chips were puffed by applied microwave. After puffing, the chips were gone through a finish roasting to moisture content to 3-4%. The finish product was packed and ready for consuming.

### Example 13

Materials: Apple, Oat Flour, Whey Protein Isolate and Ascorbic Acid.

Method:

I. Washing and pureeing apples (800 g) using a blender.

II. Adding oat flour (160 g) and whey protein isolate (20 g), ascorbic acid (3 g). Steaming the pureed mixture.

III. Then, the mixture cooling down to below 50-35° C. Sheeting to thickness of 2-1 mm.

IV. The sheets wen dried to moisture content to around 15%. The drying temperature was 60-100° C.

V. The sheets were cut into triangle chip shapes. The chips were equilibrated.

VI. Then, the chips were puffed by applied Infrared. After puffing, the chips were gone through a finish roasting to moisture content to 3-4%. The finish product was parked and ready for consuming.

### Example 14

Materials: Carrots, Oat Flour and Whey Protein Isolate.

Method:

I. Washing and pureeing carrots (400 g) using a blender.

II. Adding oat flour (80 g) and whey protein isolate (10 g).

III. Steaming the pureed mixture for inactivating enzyme reaction and gelatinizing starch.

IV. Cooling down the mixture to below 50-35° C. Extruder forming the mixture to strips. Drying the strips to moisture content 25-35% at about 100° C.

V. Sheeting to thickness of 2-1 mm. The sheets were dried to moisture content 10-20%. The drying temperature was 60-100° C.

VI. The sheets were cut into chip shapes and were equilibrated.

VII. Then, the chips were puffed by applied Infrared. After puffing, the chips were gone through a finish roasting to moisture content to 3-4%. The finish product was packed and ready for consuming.

### Example 15

Materials:

Frozen raspberries: 400 g

Oat flour: 80 g

Whey protein isolate: 1O g

Method:

I. Washing and pureeing raspberries (400 g) using a blender.

II. Adding oat flour (80 g) and whey protein isolate (10 g).

III. Steaming the pureed mixture for inactivating enzyme reaction and gelatinizing starch.

IV. Cooling down the mixture to below 50-35° C. Sheeting to thickness of 2-1 mm.

V. The sheets were dried to moisture content 10-20%. The drying temperature was 60-100° C.

VI. The sheets were cut into chip shapes and were equilibrated.

VII. Then, the chips were puffed by applied infrared. After puffing, the chips were gone through a finish roasting to moisture content to 3-4%. The finish product was packed and ready for consuming.

### Example 16

Materials: Apples, Wheat Flour

Method:

I. Washing and pureeing apples (227 g) using a blender.

II. Adding wheat flour (57 g).

III. Steaming the pureed mixture for inactivating enzyme reaction and gelatinizing starch.

IV. cooling down the mixture to below 50-35° C. sheeting to thickness of 2-1 mm.

V. The sheets were dried to moisture content 10-20%. Mean drying temperature was 60-100° C.

VI. The sheets were cut into chip shapes and were equilibrated.

VII. Then, the chips were puffed by applied microwave heating. After puffing, the chips were gone through a finish roasting to moisture content to 3-4%. The finish product was packed and ready for consuming.

### Example 17

Materials: Apples, Potato Flakes

Method:

I. Washing and pureeing apples (227 g) using a blender,

II. Adding potato flakes (57 g).

III. Steaming the pureed mixture for inactivating enzyme reaction and gelatinizing starch.

IV. Cooling down the mixture to below 50-35° C. Sheeting to thickness of 2-1 mm

V. The sheets were dried to moisture content 10-20%. Mean drying temperature was 60-100° C.

VI. The sheets were cut into chip shapes and were equilibrated.

VII. Then, the chips were puffed by applied microwave heating. After puffing. the chips were gone through a finish roasting to moisture content to 3-4 The finish product was packed and ready for consuming.

### Example 18

Materials: Apples, Carrots, Oat flour, Whey Protein Isolate, Ascorbic Acid

Method:

I. Washing and pureeing apples (200 g) and carrots (200 g) using a blender.

II. Adding ascorbic acid (1.5 g), oat flour (80 g) and whey protein isolate (10 g).

III. Steaming the pureed mixture for inactivating enzyme reaction and gelatinizing starch.

IV. Cooling down the mixture to below 50-35° C. Extruder forming the mixture to strips, Drying the strips to moisture content 25-35% at about 100° C.

V. Sheeting, to thickness of 2-1 mm. The sheets were dried to moisture content 10-20%. The drying temperature was 60-100° C.

VI. The sheets were out into chip shapes and were equilibrated.

VII. Then, the chips were puffed by applied Infrared. After puffing, the chips were gone through a finish roasting to moisture content to 3-4%. The finish product was packed and ready for consuming.

### Example 19

Materials: Fresh Apples, Oat Flour, Soy Protein Isolate, Ascorbic Acid

Method:

I. Washing and pureeing apples (400 g) using a blender.

II. Adding ascorbic acid (3 g). Adding oat Hour (80 g) and soy protein isolate (10 g) protecting apple puree from browning.

III. Steaming the pureed mixture for inactivating enzyme reaction and gelatinizing starch.

IV. Then, the mixture cooling down to below 50-35° C. Sheeting to thickness of 2-1 mm.

V. The sheets were dried to moisture content to around 10-15%. The drying temperature was 60-100° C.

VI. The shoes were cut into triangle chip shapes. The chips were equilibrated.

VII. Then, the chips were puffed by applied Infrared. After puffing, the chips went through a finish roasting to moisture content to 3-4%. The finish product was packed and ready for consuming.

### Example 20

Materials: Apples, Broccoli, Oat Flour, Quinoa Flour, Whey Protein Isolate

Method:

I. Washing and pureeing apples (300 g) and broccoli (100 g) using a blender.

II. Adding oat flour (70 g), quinoa flour (10 g), and whey protein isolate (10 g).

III. Steaming the pureed mixture for inactivating enzyme reaction and gelatinizing starch.

IV. Cooling down the mixture to below 50-35° C. Sheeting to thickness of 2-1 mm.

V. The sheets were dried to moisture content to around 10-15%. The drying temperature was 60-100° C.

VI. The sheets were cut into chip shapes and were equilibrated.

VII. Then, the chips were puffed by applied Infrared. After puffing, the chips were gone through a finish roasting to moisture content to 3-4%. The finish product was packed and ready for consuming.

### Example 21

Materials-Fresh Apples, Oat Flour, Quinoa Flour, Whey Protein Isolate

Method:

I. Washing and pureeing apples (800 g) using a blender.

II. Adding oat flour (140 g), quinoa flour (20 g) and whey protein isolate (20 g) for protecting apple puree from browning.

III. Steaming the pureed mixture for inactivating enzyme reaction and gelatinizing starch.

IV. Then, the mixture cooling down to below 50-35° C. Sheeting to thickness of 2-1 mm.

V. The sheets were dried to moisture content to around 10-15%. The drying temperature was 60-100° C.

VI. The sheets were cut into triangle chip shapes. The chips were equilibrated.

VII. Then, the chips were puffed by applied Infrared. After puffing, the chips were gone through a finish roasting to moisture content to 3-4%, The finish product was packed and ready for consuming.

### Example 22

Materials: Apples, Beets, Oat Flour, Quinoa Flour, Whey Protein Isolate

Method:

I. Washing and pureeing apples (300 g) and beets (100 g) using a blender.

II. Adding ascorbic acid (1.5 g), oat flour (70 g), quinoa flour (10 g), and whey protein isolate (10 g).

III. Steaming the pureed mixture fox inactivating enzyme reaction and gelatinizing starch.

IV. Cooling down the mixture to below 50-35° C. Extruder forming the mixture to strips. Drying the strips to moisture content 25-35% at about 100° C.

V. Sheeting to thickness of 2-1 mm. The sheets were dried to moisture content 10-20%. The drying temperature was 60-100° C.

VI. The sheets were cut into chip shapes and were equilibrated,

VII. Then, the chips were puffed by applied infrared. After puffing, the chips were gone, through a finish roasting to moisture content to 3-4%. The finish product was packed and ready for consuming.

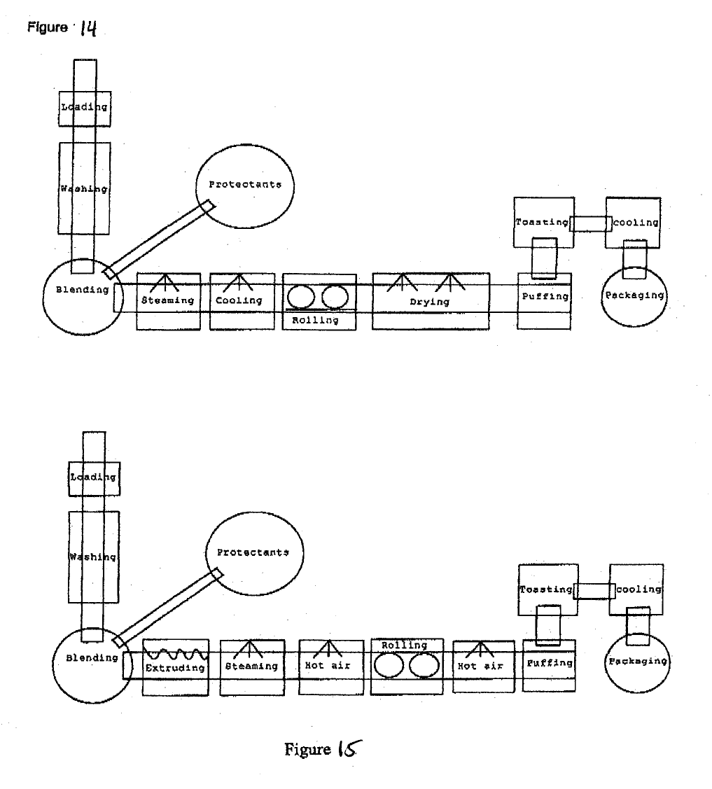

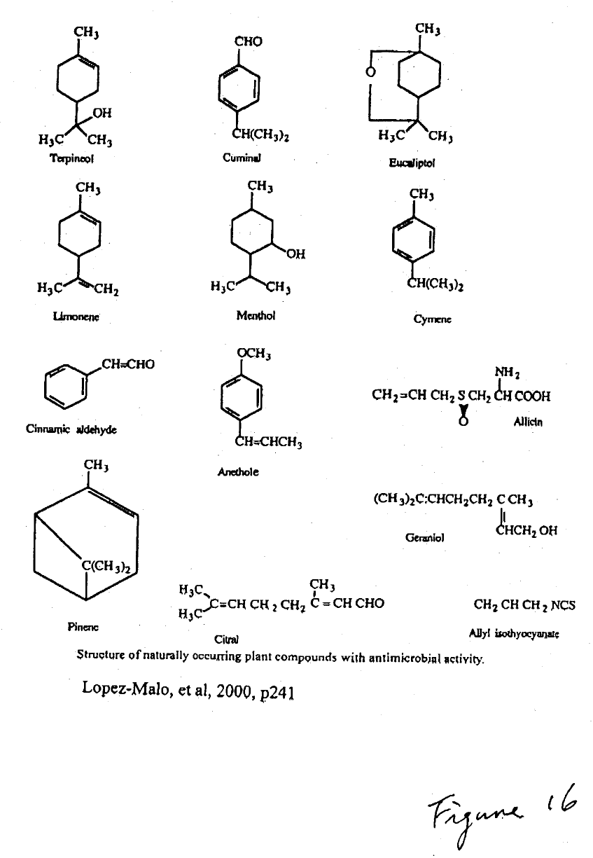

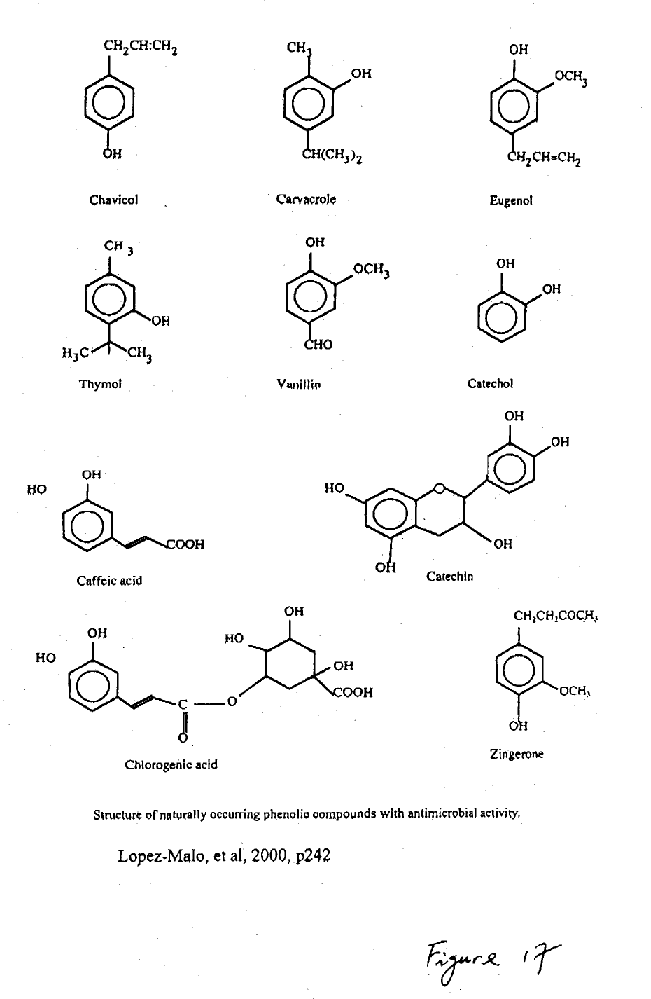

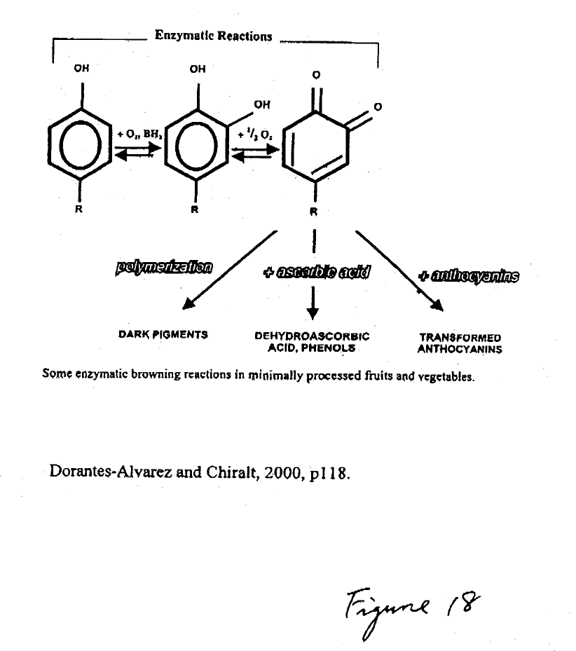

The methods for preparing the chip-like product described above are summarized in FIGS. 14 and 15.

### Example 23

I. Wash and puree apples (200 g) with protectant (20 g) using a blender.

II. Let puree stand for 40 minutes.

III. Add methanol solution to make up mixture to 50% moisture content.

IV. Centrifuge 10 mL mixture for 20 minutes.

V. Load 2 ml supernatant to Amicon Centicon-3.

VI. Centrifuge-filter the supernatant using Amicon Centicon-3 to remove the dark pigment (polymeric molecules) and collect small molecules (less than 3,000 Da) in the filtrate.

VII. Analyze total phenolics in the filtrate samples using the method of Singleton and Rossi (1965).

VIII. Use apple puree (200 g) and individual protectants (20 g) (suspended in 200 g of water) as controls.

### Example 24

The results of analysis for nutritional information required in Canada on a snack product produced as per Example 13 are shown in the following table, in comparison with those for regular potato and tortilla chips (100 g basis):

| | Potato Chip Product | | Tortilla Chip Product | | Example | |
|---|---|---|---|---|---|---|
| | Lays ™ Classic Regular | | Tostitos ™ Bite Size | | 13 | |
| Energy | 550 | C. | 518 | C. | 377 | C. |
| | 2286 | kJ | 2179 | kJ | 1579 | kJ |
| Protein | 6.1 | g | 7.9 | g | 13.8 | g |
| Fat | 35.7 | g | 26.1 | g | 1.7 | g |
| Car- | 53.6 | g | 64.3 | g | 76.8 | g |
| bohydrates | | | | | | |

While the preferred embodiments of the invention have been described above, it will be recognized and understood that various modifications may be made therein, and the appended claims are intended to cover all such modifications which may fall within the spirit and scope of the invention.

### REFERENCES

Anandaraman, S. and Reinecciuc, G. A. 1986. Stability of encapsulated orange peel oil. Food Technology 40 (11): 86.

Bakan, J. A. 1978. Microencapsulation. In: Peterson, M. S. and Johnson, A. S. (eds), Encyclopedia of Food Science.

Dorantes-Alveraz, L. and Chiralt, A. 2000. Pp 111-126 in: Minimally Processed Fruits and Vegetables: Fundamental aspects and applications. Alzamora et al (eds.), Aspen Publishes. Gaithersburg, Md.

Hall III, C. A. and Cuppett, S. 1997. Structure-activities of natural antioxidant. Chapter 9. In: Antioxidant Methodology: in vivo and in vitro Concepts. Aruoma, O. I. and Cuppett, S. L., Eds. American Oil Chemist's Society, Champaign: IL.

Hoseney, R. Carl. Principles of Cereal Science and Technology. 1986. American Association of Cereal Chemists: St. Paul, Minn.

Food and Drug Administration, Department Of Health And Human Services Title 21, Volume 3, 2 1 CFRI 84, U.S. Government Printing Office, 200 1.

Jackson L. S. and Lee K. 1991. Microencapsulation and the food industry, Lebensm.-Wiss. u.-Technol. 24: 289-297.

Levine, H. and Slade, L. 1989. Influence of the glassy and rubbery states on the thermal, mechanical and structural properties of doughs and baked products. In: Dough Rheology and Baked Product Texture. H. Faridi and J. M. Faubion, eds. Van Nostrand-Reinhold/AVI. New York: N.Y. 1990. Pp 157-330.

Lopez-Malo et al (2000) p237-263 in: Minimally Processed Fruits and Vegetables: Fundamental aspects and applications. Alzamora et al (eds.), Aspen Publishes. Gaithersburg, Md.

Luh and Woodroof, eds. 1988. Commercial Vegetable Processing. 2'd ed. Van Nostrand Reinhold: New York: N.Y.

Lusas, E. W. and Rooney, L. W. (eds.) 2001. Snack Foods Processing. Technomic Publishing Company. Lancaster, Pa.

Mazza, G. ed. 1998. Functional Foods, Biochemical and Processing Aspects. Technomic Publishing Co. Lancaster: PA.

McNamee, B. F., O'Riordan, E. D., and O'Sullivan, M. 2001. Effect of Partial replacement of gum Arabic with carbohydrates on its microencapsulation properties. J. Agricultural and Food Chemistry. 49: 3385-3388.

Nafisi-Movaghar, K. 199 1. U.S. Pat. No. 5,000,972. Method of making dried fruits.

Shewfelt, 1986. Chapter 11 in: Commercial Fruit Processing. Woodroof and Luh, (eds.), 1986. Commercial Fruit Processing. 2nd ed. AVI Publishing Company. Westport: Conn.

Singleton, V. L. and Rossi, J. A., Jr. 1965, Colorimetry of total phenolics with phosphomolybdic-phosphotungstic acid reagents. Am. J. Enol. Vitic. 16, 144-158.

Sparks, R. E. 1985. Microencapsulation. In: Grayon, M. et al. (eds). Concise Encyclopedia of Chemical Technology. New York, N.Y.: Wiley & Sons, pp 762-763.

Taga et al. (1993) U.S. Pat. No. 5,264,238. Method for manufacturing snack foods.

Woodroof and Luh, 1986. Commercial Fruit Processing. 2nd ed. AVI Publishing Company. Westport: Conn.

Vilstrup, P. (ed) 2001. Microencapsulation of Food Ingredients. Leatherhead Publishing. Leatherhead: Surrey, UK.

Zeleznak, K. J., and Hoseney, R. C. 1987. The glass transition in starch. Cereal Chemistry 64: 121-124.

1. A food product comprising:
a quantity of at least one fruit or vegetable; and
a protectant, said protectant being selected from the group consisting of: grain products, pulses, tubers and combinations thereof.

2. The food product according to claim 1 wherein the at least one fruit or vegetable is blended.

3. The food product according to claim 1 wherein the at least one fruit or vegetable is in cut pieces.

4. The food product according to claim 1 wherein the protectant is a grain product.

5. The food product according to claim 4 wherein the protectant is whole grain.

6. The food product according to claim 4 wherein fractions of the grain product are used.

7. The food product according to claim 1 in the form of a paste, a spread, a sheet, a chip or a puffed product.

8. A method of preparing a food product comprising:
coating a quantity of at least one fruit or vegetable with a protectant, said protectant being selected from the group consisting of: grain products, pulses, tubers and combinations thereof.

9. The method according to claim 8 wherein the at least one fruit or vegetable are mixed together and blended.

10. The method according to claim 8 wherein the at least one fruit or vegetable is blended and the protectant is added to the blended at least one fruit or vegetable.

11. The method according to claim 8 wherein the at least one fruit or vegetable is in cut pieces and the cut pieces are dipped in the protectant.

12. The method according to claim 8 wherein the protectant is a grain product.

13. The method according to claim 12 wherein the protectant is whole grain.

14. The method according to claim 12 wherein fractions of the grain product are used.

15. The method according to claim 8 wherein the food product is in the form of a paste, a spread, a sheet, a chip or a puffed product.

16. A method of preparing a snack product comprising:
steaming a pureed mixture of at least one fruit or vegetable and a protectant, said protectant being selected from the group consisting of: grain products, pulses, tubers and combinations thereof;
cooling the mixture and forming the mixture into a sheet;
drying the sheet and
cutting the sheet into snack products.

17. The method according to claim 16 wherein the protectant is a grain product.

18. The method according to claim 17 wherein the protectant is whole grain.

19. The method according to claim 17 wherein fractions of the grain product are used.

20. The method according to claim 16 wherein the chips are puffed.

21. The method according to claim 16 wherein the chips are puffed by applied microwave heating, fluidizied bed, uniform heating or applied infrared.

22. The method according to claim 16 including roasting the chips after puffing.
